(19) United States
(12) Patent Application Publication
(10) Pub. No.: US 2026/0230423 A1
(43) Pub. Date: Aug. 6, 2026

(54) MULTIPATH ATTACHED INPUT/OUTPUT CONTROL UNIT

(71) Applicant: International Business Machines Corporation, Armonk, NY (US)

(72) Inventors: Beth Ann Peterson, Tucson, AZ (US); Matthew Richard Craig, Sahuarita, AZ (US); Scott B. Compton, Hyde Park, NY (US); Dale F. Riedy, Poughkeepsie, NY (US); William C. Shepard, Hyde Park, NY (US)

(21) Appl. No.: 19/047,482

(22) Filed: Feb. 6, 2025

(51) Int. Cl. H04L 45/28; H04L 45/02; H04L 45/24

(52) U.S. Cl. CPC H04L 45/28; H04L 45/02; H04L 45/24

(57) ABSTRACT

A method according to one approach is for avoiding use of paths of a communication multipath attached to an input/output (I/O) control unit. The method includes: receiving, from a host, a define subsystem operation (DSO) define path usage command configured to instruct the I/O control unit of expected usage of one or more specified paths. The DSO define path usage command includes: a set first flag, the first flag being configured to restrict or allow multipath reconnections for the specified path(s) and the particular path group. The DSO define path usage command also includes a set second flag, the second flag being configured to restrict or allow the specified path(s) and the particular path group to present unsolicited status. The DSO define path usage command includes a filled list of interface identifications determining the respective specified path(s), and a path group identification determining the particular path group.

### BACKGROUND

The present invention relates to storage systems, and more specifically, this invention relates to temporarily restricting communication paths.

In today's society, computer systems are commonplace and may be found in the workplace, at home, or at school. Computer systems may include data storage systems, or disk storage systems, to process and store data. Data storage systems, or disk storage systems, are utilized to process and store data. A storage system may include one or more disk drives. The disk drives may be configured in an array, such as a Redundant Array of Independent Disks (RAID) topology, to provide data security in the event of a hardware or software failure. The data storage systems may be connected to a host, such as a mainframe computer. The disk drives in many data storage systems have commonly been known as Direct Access Storage Devices (DASD). DASD devices typically store data on a track, which is a circular path on the surface of a disk on which information is recorded, and from which recorded information is read.

Network access has been implemented in an attempt to improve the availability of an increasing amount of data in such DASDs. As a result, the network infrastructure used to transfer data to cloud computing locations has become increasingly important to data processing. It follows that any network downtime has a significant impact on the performance of the system.

### SUMMARY

A method, according to one approach, is for avoiding use of paths of a communication multipath attached to an input/output (I/O) control unit. The method includes: receiving, from a host, a define subsystem operation (DSO) define path usage command configured to instruct the I/O control unit of expected usage of one or more specified paths in a particular path group for all devices in the path group. The DSO define path usage command includes: a set first flag, the first flag being configured to restrict or allow multipath reconnections for the specified path(s) and the particular path group. The DSO define path usage command also includes a set second flag, the second flag being configured to restrict or allow the specified path(s) and the particular path group to present unsolicited status. The DSO define path usage command additionally includes a filled list of interface identifications (IDs) configured to determine the respective specified path(s). Furthermore, the DSO define path usage command includes an identified path group ID configured to determine the particular path group.

A computer program product, according to another approach, includes: one or more computer-readable storage media. The computer program product also includes program instructions that are stored on the one or more storage media to perform any combination of the foregoing methodologies.

A computer system, according to another approach, includes: a processor set, and one or more computer-readable storage media. The computer system also includes program instructions that are stored on the one or more storage media to cause the processor set to perform any combination of the foregoing methodologies.

A method, according to still another approach, is for selectively preventing use of paths of a communication multipath attached to an I/O control unit. The method includes: experiencing a failure on one or more of the paths in the communication multipath. In response to experiencing the failure, building and issuing a new message type with a raised attention interrupt to a host. A DSO define path usage command is further received from the host. The DSO define path usage command includes a set first flag indicating whether multipath reconnections for the failed path(s) in a particular path group should be restricted or allowed. The command also includes a set second flag indicating whether to restrict or allow the failed path(s) in the particular path group from presenting unsolicited statuses. The command also includes a filled list of interface IDs identifying the failed path(s). Furthermore, the command includes a path group ID determining the particular path group. The method thereby includes using the set first flag and the set second flag to configure the failed path(s) which correspond to the filled list of interface IDs and the path group ID.

A computer system, according to yet another approach, includes: a processor set, and one or more computer-readable storage media. The computer system also includes program instructions that are stored on the one or more storage media to cause the processor set to perform any combination of the foregoing methodologies.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a detailed view of logical and/or physical paths in a communication multipath of the distributed system of FIG. 2A, in accordance with one approach.

FIG. 3 is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for at least temporarily avoiding the use of specific paths using a host system directive of a communication multipath attached to an I/O control unit. Approaches herein are thereby able to provide protection on the recovery path usages via a host directive to the control unit that is able to define correct (e.g., permitted or preferred) path usage. This desirably avoids the complicated and resource intensive process of removing paths from path groups, only to expend similar resources to add the recovered paths to the same or other path groups. Approaches herein are thereby desirably able to reduce overall consumption of system resources (e.g., available compute overhead, network bandwidth, electrical current and/or voltage, etc.) while maintaining performance of received I/O requests with no added latency, e.g., as will be described in further detail below.

In one general approach, a method is for avoiding use of paths of a communication multipath attached to an I/O control unit. The method includes: receiving, from a host, a DSO define path usage command configured to instruct the I/O control unit of expected usage of one or more specified paths in a particular path group for all devices in the path group. The DSO define path usage command includes: a set first flag, the first flag being configured to restrict or allow multipath reconnections for the specified path(s) and the particular path group. The DSO define path usage command also includes a set second flag, the second flag being configured to restrict or allow the specified path(s) and the particular path group to present unsolicited status. The DSO define path usage command additionally includes a filled list of interface IDs configured to determine the respective specified path(s). Furthermore, the DSO define path usage command includes an identified path group ID configured to determine the particular path group.

Approaches herein are thereby able to provide protection on the recovery path usages via a host directive to the control unit that is able to define correct (e.g., permitted or preferred) path usage. This desirably avoids the complicated and resource intensive process of removing paths from path groups, only to expend a similar amount of resources to add the recovered paths to the same or other path groups. The operations of method 300 are thereby desirably able to reduce overall consumption of system resources (e.g., available compute overhead, network bandwidth, electrical current and/or voltage, etc.) while maintaining performance of received I/O requests with no added latency.

In some implementations, the method further includes using the set first flag and the set second flag to configure paths which correspond to the filled list of interface IDs and the identified path group ID. It follows that the set first flag, the set second flag, the filled list of interface IDs, and the identified path group ID that are received are able to cause the I/O control unit to ensure that each path of a communication multipath is used to conduct specific types of operations during recovery of one or more failed paths in the communication multipath. In some approaches, flags set in a response apply to all devices in an identified path group ID. In other words, the indications made in a received response may be applied to any devices that are connected to the communication paths in any path group(s) identified in the response. This improves data transfer rates, further reducing overhead, particularly during error recovery procedures.

In some implementations, the method further includes receiving a response to the DSO define path usage command from a host. The response may include: a set first flag, a set second flag, a filled list of interface IDs, and an identified path group ID. Accordingly, the method further includes using the set first flag and the set second flag to configure paths which correspond to the filled list of interface IDs and the identified path group ID. Moreover, the set first flag, the set second flag, the filled list of interface IDs, and the identified path group ID may be configured to instruct the I/O control unit of expected usage of the paths that correspond to the filled list of interface IDs and the identified path group ID during recovery of one or more failed paths in the communication multipath. Accordingly, the set first flag and the set second flag may be applied to all devices in the identified path group ID.

Again, the details that are received are able to cause the I/O control unit to ensure that each path of a communication multipath is used to conduct specific types of operations during recovery of one or more failed paths in the communication multipath. For instance, the indications made in a received response may be applied to any devices that are connected to the communication paths in any path group(s) identified in the response. As noted above, this improves data transfer rates, further reducing overhead, particularly during error recovery procedures.

In some implementations, the paths in the communication multipath are logical and/or physical connections. Accordingly, any of the approaches herein may be applied in situations involving logical and/or physical connections extending between locations of a distributed system. Thus, regardless of the type and/or location of an error (e.g., failure) experienced across a communication multipath, approaches herein are able to avoid degraded performance during the recovery procedure. This is achieved at least in part by selectively modifying each communication path to operate as desired (e.g., carry specific types of requests) during the recovery procedure. Accordingly, I/O requests may still be satisfied during the recovery procedure, while specific types of requests (e.g., multipath reconnect requests) are redirected to other paths, e.g., as will be described in further detail below.

In one general approach, a computer program product includes: one or more computer-readable storage media. The computer program product also includes program instructions that are stored on the one or more storage media to perform any combination of the foregoing methodologies.

In another general approach, a computer system includes: a processor set, and one or more computer-readable storage media. The computer system also includes program instructions that are stored on the one or more storage media to cause the processor set to perform any combination of the foregoing methodologies.

In still another general approach, a method is for selectively preventing use of paths of a communication multipath attached to an I/O control unit. The method includes: experiencing a failure on one or more of the paths in the communication multipath. In response to experiencing the failure, building and issuing a new message type with a raised attention interrupt to a host. A DSO define path usage command is further received from the host. The DSO define path usage command includes a set first flag indicating whether multipath reconnections for the failed path(s) in a particular path group should be restricted or allowed. The command also includes a set second flag indicating whether to restrict or allow the failed path(s) in the particular path group from presenting unsolicited statuses. The command also includes a filled list of interface IDs identifying the failed path(s). Furthermore, the command includes a path group ID determining the particular path group. The method thereby includes using the set first flag and the set second flag to configure the failed path(s) which correspond to the filled list of interface IDs and the path group ID.

Again, approaches herein are thereby able to provide protection on the recovery path usages via a host directive to the control unit that is able to define correct (e.g., permitted or preferred) path usage. This desirably avoids the complicated and resource intensive process of removing paths from path groups, only to expend a similar amount of resources to add the recovered paths to the same or other path groups. The operations of method 300 are thereby desirably able to reduce overall consumption of system resources (e.g., available compute overhead, network bandwidth, electrical current and/or voltage, etc.) while maintaining performance of received I/O requests with no added latency.

In some implementations, the failed path(s) are recovered in response to using the set first flag and the set second flag to configure the failed path(s). Moreover, in response to the failed path(s) being recovered, the I/O control unit may resume using the recovered path(s) to perform multipath reconnections and present unsolicited statuses. As noted above, limiting specific communication paths to only perform certain types of requests allows for approaches herein to desirably control how each of the paths in a communication multipath are used during a recovery procedure. This allows for failed paths to maintain performance of I/O requests even during the recovery process, while preventing or limiting other types of requests from being performed. Approaches herein are thereby able to maintain high throughput even with failed communication paths.

In some implementations, the failed path(s) include logical connections, while the paths in the communication multipath are logical and/or physical connections. Moreover, using the set first flag and the set second flag to configure the failed path(s) includes: causing the failed path(s) to not perform multipath reconnections and/or not present unsolicited statuses. However, the failed path(s) are able to perform I/O commands, while remaining (non-failed) paths in the communication multipath are able to perform I/O commands, perform multipath reconnections, and present unsolicited statuses. In other words, failed paths may have restricted performance while paths that have not experienced any issues may remain allowed to satisfy any type of received request, thereby maintaining high throughput for the system even during the recovery procedure.

Accordingly, any of the approaches herein may be applied in situations involving logical and/or physical connections extending between locations of a distributed system. Thus, regardless of the type and/or location of an error (e.g., failure) experienced across a communication multipath, approaches herein are able to avoid degraded performance during the recovery procedure. This is achieved at least in part by selectively modifying each communication path to operate as desired (e.g., carry specific types of requests) during the recovery procedure. Accordingly, I/O requests may still be satisfied during the recovery procedure, while specific types of requests (e.g., multipath reconnect requests) are redirected to other paths, e.g., as will be described in further detail below.

In yet another general approach, a computer system includes: a processor set, and one or more computer-readable storage media. The computer system also includes program instructions that are stored on the one or more storage media to cause the processor set to perform any combination of the foregoing methodologies.

In other implementations, several hosts in a subsystem are using logical paths that extend along a same physical path. At least one of the hosts experiences issues on the physical path and initiates a recovery procedure. The host may thereby issue a Restrict Path Usage directive that causes the I/O control unit to restrict path usage (e.g., for all the unsolicited statuses, multipath reconnects, etc.), for any host(s) using this failed path. This first host would thereby be able to perform a recovery of the failed path while allowing other hosts to not be impacted by any repairs occurring on the physical path (e.g., from a status and/or reconnect perspective). The other hosts using the same physical path may further be able to use the path to receive and/or satisfy respective I/Os. Thus, even in situations where more than one host detected issues with the physical path and initiated their own recovery (e.g., even including sending their own directives), whichever host restricted the physical path usage would benefit the others by not getting excess ‘noise’ during their own recovery processing. However, in situations where one host has restricted the path for use and the recovery fails, the other host may initiate their own recovery procedures, e.g., as would be appreciated by one skilled in the art after reading the present description. Again, approaches herein are thereby able to achieve host directive to control (e.g., allow/restrict) path usage for unsolicited events and/or reconnects, as will be described in further detail below.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as new error recovery code in block 150 for at least temporarily avoiding the use of specific paths using a host system directive of a communication multipath attached to an I/O control unit. Approaches herein are thereby able to provide protection on the recovery path usages via a host directive to the control unit that is able to define correct (e.g., permitted or preferred) path usage. This desirably avoids the complicated and resource intensive process of removing paths from path groups, only to expend similar resources to add the recovered paths to the same or other path groups. Approaches herein are thereby desirably able to reduce overall consumption of system resources (e.g., available compute overhead, network bandwidth, electrical current and/or voltage, etc.) while maintaining performance of received I/O requests with no added latency, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

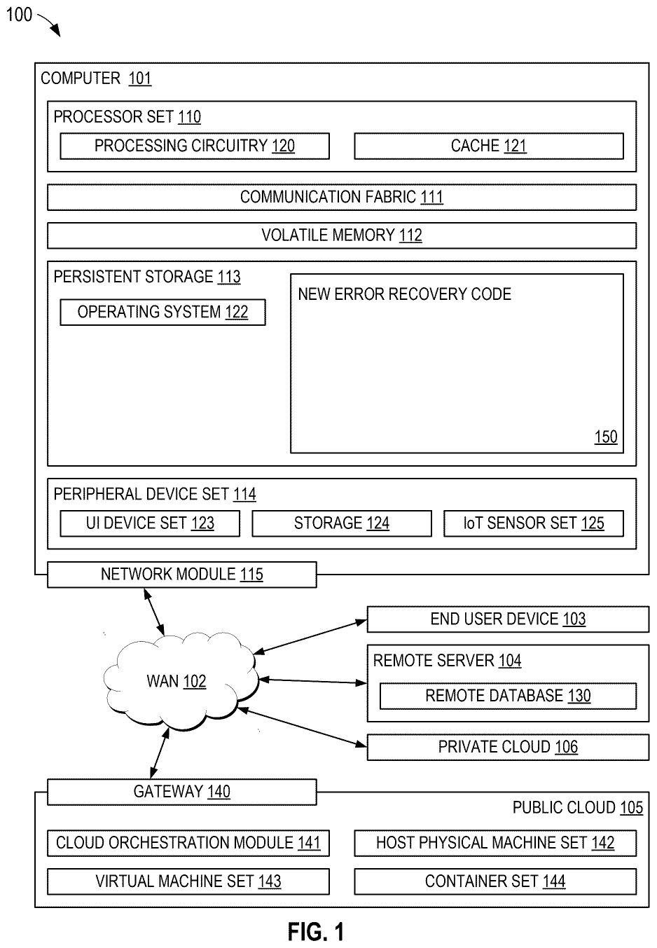

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, computer systems are commonplace and may be found in the workplace, at home, or at school. Computer systems may include data storage systems, or disk storage systems, to process and store data. Data storage systems, or disk storage systems, are utilized to process and store data. A storage system may include one or more disk drives. The disk drives may be configured in an array, such as a Redundant Array of Independent Disks (RAID) topology, to provide data security in the event of a hardware or software failure. The data storage systems may be connected to a host, such as a mainframe computer. The disk drives in many data storage systems have commonly been known as Direct Access Storage Devices (DASD). DASD devices typically store data on a track, which is a circular path on the surface of a disk on which information is recorded, and from which recorded information is read.

These disk drives implement a Count, Key, and Data (CKD) format on the disk drives. A record is a set of one or more related data items grouped together for processing, such that the group may be treated as a unit. Disk drives utilizing the CKD format have a special “address mark” on each track that signifies the beginning of a record on the track. After the address mark is a three-part record beginning with the count field that serves as the record ID and also indicates the lengths of the optional key field and the data field, both of which follow. Also on the track, there is normally one Home Address (HA) that defines the physical location of the track and the condition of the track. The HA typically contains the physical track address, a track condition flag, a cylinder number (CC) and a head number (HH). The combination of the cylinder number and the head number indicates the track address, commonly expressed in the form CCHH. The HA contains the “physical track address” which is distinguished from a “logical track address.” Some operating systems, such as the IBM Virtual Machine (VM) operating system, employ a concept of “virtual disks” referred to as user mini-disks, and thus it is necessary to employ logical addresses for the cylinders rather than physical addresses.

In addition, Write Ahead Data Set (WADS) tracks may be included in a storage area network. The write-ahead data set (WADS) is a small DASD data set containing a copy of log records reflecting committed operations in the on-line data set OLDS buffers that have not yet been written to the OLDS. Moreover, WADS space may continually be reused after the records it contains are written to the OLDS.

The computer systems, as previously described, use I/O operations to transfer data between memory and I/O devices of a data storage and/or processing environment. For instance, data is written from memory to one or more I/O devices, and data is read from one or more I/O devices to memory by executing I/O operations. To facilitate processing of I/O operations, an I/O subsystem of the processing environment is employed. The I/O subsystem is coupled to main memory and the I/O devices of the processing environment and directs the flow of information between memory and the I/O devices. One example of an I/O subsystem is a channel subsystem. The channel subsystem uses channel paths as communications media. Each channel path includes a channel coupled to a control unit; the control unit being further coupled to one or more I/O devices.

The channel subsystem employs channel command words to transfer data between the I/O devices and memory. A channel command word (CCW) specifies the command to be executed, and for commands initiating certain I/O operations, it designates the memory area associated with the operation, the action to be taken whenever transfer to or from the area is completed, and other options. During I/O processing, a list of channel command words is fetched from memory by a channel. The channel parses each command from the list of channel command words and forwards a number of the commands, each command in its own entity, to a control unit (processor) coupled to the channel. The control unit then processes the commands. The channel tracks the state of each command and controls when the next set of commands are to be sent to the control unit for processing. The channel ensures that each command is sent to the control unit in its own entity. Further, the channel infers certain information associated with processing. It follows that any network downtime has a significant impact on the performance of the system. A host system can be attached to an I/O control unit in an attempt to improve access to I/O devices using multiple I/O paths. An I/O path (or just “path” as used herein) can include a physical link or a logical link (e.g., logical path) where one physical link may support many logical paths. The host system and I/O control unit can manage the multiple paths to an I/O device as a single entity (a path group) for certain purposes, e.g., such as handling exclusive access to the device (device reserve), control unit reconnecting to the host (e.g., after disconnecting to free up a link when an I/O command cannot be completed sufficiently quickly), and when the control unit presents unsolicited device status not tied to a particular path.

In situations where an error condition affects a logical path to one or more devices, the control program may perform various recovery actions in an attempt to clear the error on the logical path. Recovery actions include issuing I/O commands on the logical path to obtain status from the control unit and/or to reset the state of the logical path and I/O device. While attempting error recovery for a path, it is desirable to avoid any other I/O activity on that path, both to simplify determination of the state of the path and the I/O device(s) and to avoid elongating the recovery process due to additional processing.

It is important to complete recovery actions quickly because application program I/Os may be blocked. The control program might prevent unrelated I/O requests from being started on the path being recovered (the recovery path) by blocking those I/Os to the affected devices. However, that does not prevent the I/O control unit from using the recovery path to present unsolicited status or for reconnecting an I/O command after a disconnect (e.g., such as an I/O command used for recovery that was purposely issued on an unaffected path).

According to a non-limiting example, IBM SYSTEM Z includes a Suspend Multipath Reconnect (SMR) I/O command which can be pre-pended to an I/O request to prevent reconnecting on a different path. However, SMR is added to each I/O request, and for many I/O commands the I/O architecture prohibits pre-pending. SMR is typically used by the device support code error recovery procedure (ERP) for recovering a single I/O request, but not for path recovery. Although the host control program can prevent reconnection on a recovery path by removing the path from the path group, there are significant drawbacks in doing so. For instance, removing the recovery path from the path group is an extreme action resulting in that path no longer being used, while the goal of recovery is to repair a path such that it can remain in the path group. The control unit may also be called to present unsolicited status on ungrouped paths. When an I/O device is reserved, it is reserved to a path group. I/O commands from an ungrouped path could be blocked or result in more recovery actions.

In sharp contrast to any drawbacks and/or limitations to achievable performance experienced by conventional products, approaches herein are able to provide protection on the recovery path usages via a host directive to the control unit that is able to define correct (e.g., permitted or preferred) path usage. This desirably avoids the complicated and resource intensive process of removing paths from path groups, only to expend a similar amount of resources to add the recovered paths to the same or other path groups. Approaches herein are thereby desirably able to reduce overall consumption of system resources (e.g., available compute overhead, network bandwidth, electrical current and/or voltage, etc.) while maintaining performance of received I/O requests with no added latency, e.g., as will be described in further detail below.

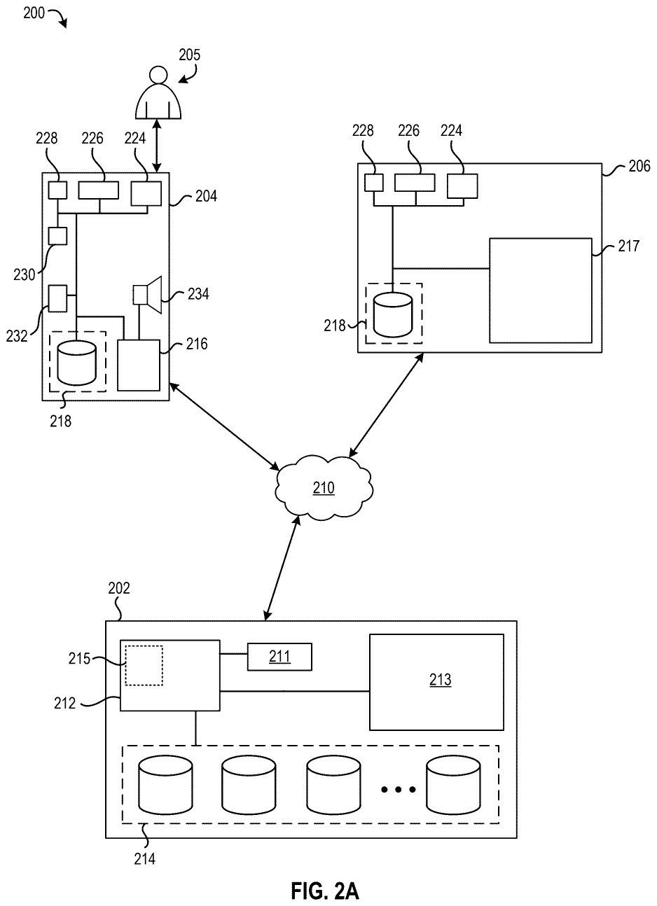

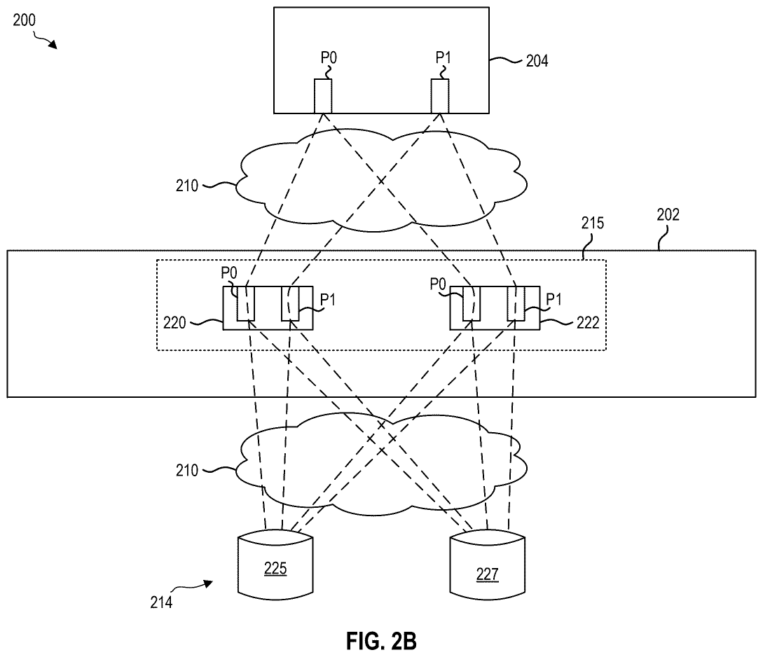

Looking now to FIGS. 2A-2B, a distributed system 200 is depicted in different levels of detail according to given approaches. As an option, aspects and/or components of the present system 200 as illustrated in FIGS. 2A and/or 2B may be implemented in conjunction with features from any other approach listed herein, such as those described with reference to the other FIGS., e.g., such as FIG. 1. However, such system 200 and others presented herein may be used in various applications and/or in permutations which may or may not be specifically described in the illustrative approaches listed herein. Further, the system 200 presented herein may be used in any desired environment. Thus FIGS. 2A-2B (and the other FIGS.) may be deemed to include any possible permutation.

Looking first to FIG. 2A, a high level view of the distributed system 200 is illustrated in accordance with one approach. As shown, the system 200 includes a central server 202 that is connected to a host device 204 accessible to the host 205, and a remote system 206. The central server 202, host device 204, and remote system 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between host device 204, remote system 206, and/or central server 202, regardless of the amount of separation which exists therebetween, e.g., despite being positioned at different geographical locations.

However, it should be noted that two or more of the host device 204, remote system 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc. ; etc., or any other type of connection which would be apparent to one skilled in the art after reading the present description.

The terms “user”, “client”, and “host” are in no way intended to be limiting. For instance, while users, clients, and/or hosts may be described as being individuals in various implementations herein, any one or more of them may be an application, an organization, a preset process, etc. The use of “data” and “information” herein is in no way intended to be limiting either, and may include any desired type of details, e.g., depending on the type of operating system implemented on the host device 204, remote system 206, and/or central server 202. For example, video data, audio data, sensor data, metadata, outputs produced by AI based models, images, etc. may be sent to the central server 202 and/or remote system 206 from host device 204 for storage and/or processing using one or more AI based models, e.g., such as a foundation model and/or machine learning models. It follows that system 200 is able to satisfy I/O requests involving data in local storage and/or elsewhere.

The central server 202 includes a large (e.g., robust) processor 212 coupled to a cache 211, an AI module 213, and a data storage array 214 having a relatively high storage capacity. The AI module 213 may include any desired number and/or type of AI based models. In preferred approaches, the AI module 213 and/or processor 212 includes one or more AI based models that have been trained to evaluate various details of a system and identify a most efficient manner of recovering from one or more path failures while maintaining reliable I/O operation. The AI based models may communicate with (e.g., provide outputs, requests, instructions, etc. to) an I/O control unit in order to impact (e.g., control) the various paths that are in a communication multipath. In some approaches, the I/O control unit 215 is implemented in the processor 212, but may be located elsewhere in other approaches, e.g., such as AI module 213. AI module 213 and/or processor 212 may thereby be used to perform one or more of the operations in method 300, e.g., as will be described in further detail below.

With continued reference to FIG. 2A, I/O control unit 215 in processor 212 may further be attached to (e.g., connected to) a communication multipath. As the name suggests, the communication multipath includes multiple different paths that provide a connection over which communication may occur. The different paths in (e.g., incorporated by) a communication multipath may include logical and/or physical connections. For example, physical paths may include wired connections, physical buses, fiberoptic cables, etc., while the logical paths may include communication channels between running applications, network connections, logic paths, etc. It follows that one or more different logical paths may extend across a given physical path. Moreover, two or more logical and/or physical paths may be combined into a path group that may be referenced and/or modified together. It follows that “path group” as used herein refers to any desired number and/or type of paths that have been grouped into a communication multipath which can be addressed, modified, ended, etc. together.

Host device 204 also includes a processor 216 which is coupled to memory 218. The host device 204 may receive inputs from, and interface with, host 205. For instance, the host 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the host 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The host device 204 also includes a speaker 234 which may be used to play (e.g., project) audio signals for the host 205 to hear.

Some data may be received from host 205 for storage and/or evaluation using AI module 213. For instance, system log information may be received as a result of the host 205 using one or more applications, software programs, temporary communication connections, etc. running on the host device 204. For example, the host 205 may submit one or more I/O (e.g., data operation) requests directed to the data storage array 214, and the requests may be evaluated by the processor 212 and/or AI module 213 of central server 202 in response to being received. In response to receiving the request, the I/O control unit 215 of processor 212 may submit requests to the data storage array 214 and/or remote system 206 for data referenced in the received I/O requests. This allows for approaches herein to maintain a number of logical and physical paths between the I/O control unit 215 and various locations in storage, thereby significantly increasing the achievable throughput of the system. For instance, data (e.g., information, metadata, readings, etc.) may be sent along each of the logical and/or physical paths in parallel, increasing throughput.

Looking now to the remote system 206 of FIG. 2A, the components included therein vary in number, type, configuration, arrangement, etc., depending on the desired approach. For instance, controller 217 is coupled to memory 218, a display screen 224, keys of a computer keyboard 226, and a computer mouse 228. While the remote system 206 is depicted as having a particular configuration with components therein, it should be noted that paths in the communication multipath may extend between the I/O control unit 215 and any desired type of I/O component, e.g., that is connected to the same network 210. In some approaches, the I/O control unit 215 sends relevant portions of received I/O requests to controller 217 and/or memory 218 for implementation (e.g., performance). The specific paths used to send the relevant portions of the request and/or return the requested data may be selected using any of the approaches herein, e.g., such as method 300 below.

Looking now to FIG. 2B, a more detailed view of the logical and/or physical paths in a communication multipath and how they extend between different locations in the system 200 is illustrated in accordance with one approach. The networks 210 are preferably SANs. However, host device 204 can be connected to external systems (e.g., the external “world”) via a WAN or other types of networks. It should be noted that approaches herein may be implemented differently. For instance, the central server 202 may be connected directly (not over a network) to storage array 214, e.g., as described in further detail below. In other approaches, network 210 may be part of a same (shared) network, e.g., such as the Internet, LANs, PSTNs, SANs, internal telephone networks, etc. It follows that communication between locations may be achieved using requests, commands, etc., other than small computer systems interface (SCSI) commands as described in various approaches herein. As a result, any desired information, data, commands, instructions, responses, requests, etc. may be sent between host device 204, central server 202, and/or storage array 214, regardless of the amount of separation which exists therebetween, e.g., despite being positioned at different geographical locations.

However, it should be noted that two or more of the host device 204, central server 202, and storage array 214 may be connected differently in some approaches. According to an example, which is in no way intended to limit the invention, two servers may be located relatively close to each other and connected by a wired connection, e.g., a cable, a fiber-optic link, an Ethernet link, a wire, etc., or any other type of connection which would be apparent to one skilled in the art after reading the present description. It should also be noted that the term “host” is in no way intended to be limiting. For instance, while a host may be described as an individual in some implementations herein, a host may be an application, an organization, a preset process, etc. The use of “data” and “information” herein is in no way intended to be limiting either, and may include any desired type of details, e.g., depending on the type of operating system implemented at host device 204, on central server 202, and/or at storage array 214.

For instance, in data center environments, a host may be connected to SAN storage controllers. This connectivity may be achieved using interconnect protocols like Internet small computer systems interface (iSCSI), fiber channel (FC), iSCSI Extensions for RDMA (iSER), etc. It follows that in order to access storage, a host discovers storage devices that are connected to them, and logs into the storage using an interconnect protocol, e.g., as mentioned above. Once logged into a target controller, the host is able to issue I/Os on the devices that are mapped to that host, as if they were locally present.

Host device 204 includes ports P0, P1, each of which are able to exchange information over connections that extend to ports P0, P1 of nodes 220, 222 as shown. Each of ports P0, P1 at nodes 220, 222 may also be connected to logical unit numbers (LUNs) that are physically located in memory components of the storage array 214 in some approaches, managed at a remote location over a network, etc. It follows that each of the nodes 220, 222 of the central server 202 connect the host device 204 to the LUNs in the storage array 214. Moreover, the I/O control unit 215 preferably monitors each of the ports and the various communication paths (dashed lines) that are running therebetween. For instance, the I/O control unit 215 may receive incoming I/O requests and identify the specific paths in a communication multipath that each of the I/O requests should be issued on. This may be based at least in part on target data storage locations, throughput capabilities of different logical and/or physical paths between the ports, a number of outstanding I/O requests, past performance, outputs (e.g., predictions) generated by one or more trained AI based models, etc.

Each of the nodes 220, 222 are shown as connecting both ports P0, P1 at the host device 204 to both of the storage devices in the array 214. Each of the dashed lines represent the paths of a communication multipath connecting various locations (e.g., components) in system 200. These paths may correspond to (e.g., represent) physical and/or logical connections that allow for information to be exchanged between the connected locations. In some approaches, a physical connection extending between port P0 of node 220 and LUN 225 may allow for (e.g., carry) multiple different logical connections to be established and extend therebetween.

It should also be noted that the physical and/or logical communication paths may be used differently depending on the situation. For instance, port P0 at host device 204 is connected to LUN 225 through port P0 of node 220 as well as port P0 of node 222. While both paths may be configured to transfer information (e.g., data, I/O requests, operations, etc.) to LUN 225, one of the paths may be designated as the preferred communication path between port P0 of host device 204 and LUN 225, while the redundant path is reserved for backup. For instance, in the present approach, the preferred path extends through both P0 and P1 of node 220, while the backup communication path extends through P0 and P1 of node 222.

According to an example, which is in no way intended to be limiting, LUN 225 may be accessed via node 220, as the communication path between host device 204 and LUN 225 running through node 220 is active optimized. In this example, LUN 227 may similarly be accessed via node 222, as the communication path between host device 204 and LUN 227 running through node 222 is active optimized. In some approaches, the number of LUNs being accessed is divided about evenly between the available nodes of the central server 202. For example, in a situation involving 8 different LUNs, the odd numbered LUNs may be accessed using a first node, while even numbered LUNs are accessed using a second node. In other words, the odd numbered LUNs will have active optimized paths extending through the first node, while even numbered LUNs will have active optimized paths extending through the second node. This example may be implemented in systems that implement SCSI based communication, in which the preferred path may be indicated as “active optimized,” while the backup communication path is indicated as “active non-optimized.” This allows for information to be exchanged between host device 204 and LUN 225 efficiently, in addition to providing a remedy for situations where the preferred communication path becomes unavailable. Similarly, port P1 at host device 204 is connected to LUN 227 through port P1 of node 220 as well as port P1 of node 222. It follows that regardless of whether node 220 or node 222 goes offline, information may still be sent from the host device 204 to the appropriate LUN in storage array 214. For example, while I/O requests are sent along preferred communication paths to the appropriate LUNs, in situations where a path and/or node experiences an error (e.g., user specific error, going offline, etc.), the host may begin issuing I/O requests along non-preferred (e.g., redundant) communication paths, e.g., as would be appreciated by one skilled in the art after reading the present description.

Looking still to FIG. 2A, storage array 214 may be directly attached to the nodes 220, 222 in some approaches, while in some approaches the storage may be exposed to nodes 220, 222 via storage virtualization, e.g., over network 210. While host device 204 has two LUNs 225, 227 exposed from I/O control unit 215, LUN 225 may have a preferred communication path extending through node 220, and LUN 227 may have a preferred communication path that extends through node 222. However, this may change during use. For instance, in situations where one or more of the communication paths and/or storage nodes 220, 222 experience an error (e.g., go offline), at least some of the traffic is transferred from the path(s) and/or node(s) offline, to alternate path(s) and/or node(s). The alternate path(s) and/or node(s) can facilitate the performance of I/O requests while the other path(s) and/or node(s) are temporarily offline, e.g., during repair. Again, approaches herein are able to provide protection on recovery path usages via a host directive to the control unit that is able to define correct (e.g., permitted or preferred) path usage. This desirably avoids the complicated and resource intensive process of removing paths from path groups, only to expend a similar amount of resources to add the recovered paths to the same or other path groups. Approaches herein are thereby desirably able to reduce overall consumption of system resources (e.g., available compute overhead, network bandwidth, electrical current and/or voltage, etc.) while maintaining performance of received I/O requests with no added latency, e.g., as will be described in further detail below.

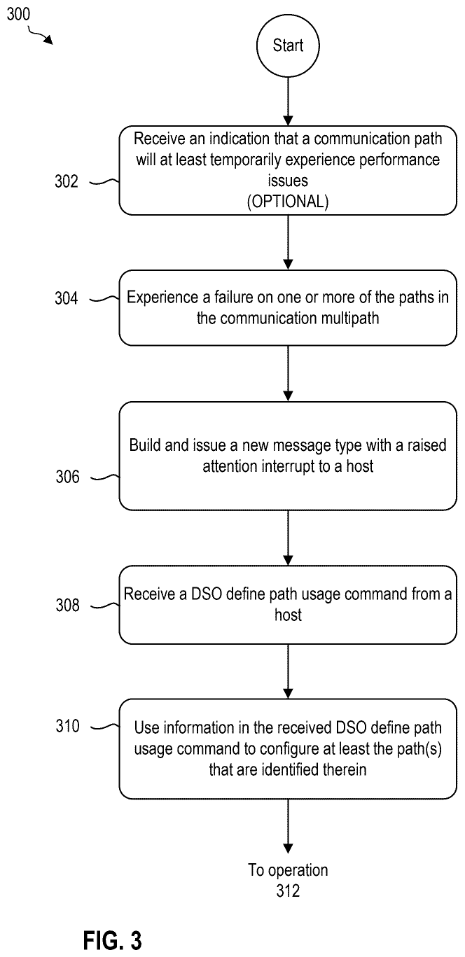

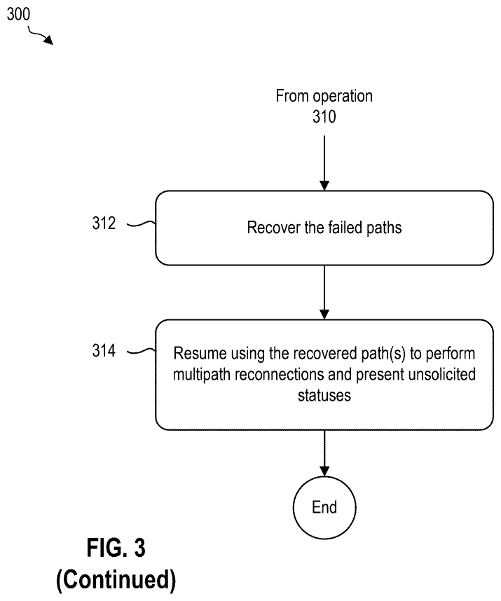

Looking now to FIG. 3, a flowchart of a method 300 for at least temporarily avoiding the use of specific paths using a host system directive of a communication multipath attached to an I/O control unit is shown according to one approach. For instance, operations in method 300 reduce the amount of information transferred along paths that are being recovered, e.g., following an issue and/or failure. This desirably allows for the path(s) experiencing the issue to be remedied before they are used again.

The method 300 may be performed in accordance with the present invention in any of the environments depicted in FIGS. 1-2B, among others, in various approaches. Of course, more or less operations than those specifically described in FIG. 3 may be included in method 300, as would be understood by one of skill in the art upon reading the present descriptions.

Each of the steps of the method 300 may be performed by any suitable component of the operating environment. For example, any one or more of the operations in method 300 may be performed by a controller at a central location (e.g., see processor 212 and/or controller 217 of FIG. 2A). In other approaches, the method 300 may be partially or entirely performed by a controller, a processor, a computer, etc., or some other device having one or more processors therein. Thus, in some approaches, method 300 may be a computer-implemented method. Moreover, the terms computer, processor and controller may be used interchangeably with regards to any of the approaches herein, such components being considered equivalents in the many various permutations of the present invention.

Moreover, for those approaches having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 of method 300 optionally includes receiving an indication that a communication path will at least temporarily experience performance issues. In other words, in some instances, an indication is received which outlines that a specific one or more of the paths in a communication multipath may experience an error and/or be intentionally taken offline. For instance, an indication may be received from an administrator, an AI based model, etc., before a path is taken offline for modification. This indication may be examined and used to transfer traffic on the given path before it is taken offline to avoid downtime and maintain desired throughput levels.

In other approaches, one or more AI based models may be trained to evaluate performance data received across different paths of a communication multipath and predict errors before they impact actual performance. In such approaches, outputs generated by the AI based models may be used to preemptively modify (e.g., fix, replace, update, etc.) the paths in the communication multipath at the point that minimizes downtime for the system. For example, the AI based models may be trained to evaluate real time performance, predicted workloads, type of error(s), user feedback, security protocols, preconfigured settings, etc., and take (e.g., cause) preliminary steps based at least in part on the evaluation. As noted above, logical communication paths may be transferred to different physical communication paths to avoid data loss and reduce downtime. However, in situations where unexpected issues occur, method 300 may simply begin at operation 304, as no preliminary indication is available.

There, operation 304 includes experiencing a failure on one or more of the paths in the communication multipath. In other words, operation 304 involves experiencing some undesirable change in the performance of (e.g., exchange of information along) the logical and/or physical paths that make up a communication multipath. The failure may be a performance based error that negatively impacts various details of the logical and/or physical path(s) themselves. In other approaches, the failure may be caused by an I/O control unit that manages the logical and/or physical paths. Again, different numbers and/or types of failures (e.g., errors) may be experienced depending on the situation.

Method 300 further advances from operation 304 to operation 306 in response to experiencing the failure. There, operation 306 includes building and issuing a new message type with a raised attention interrupt to a host. In other words, operation 306 involves the I/O control unit building a new message type (e.g., Path Status, Channel Status, etc.), which includes an attention interrupt. This new message type and attention interrupt are preferably able to inform the host of the failure(s) experienced in operation 304. The I/O control unit preferably issues the new message on a communication path other than the path(s) that have failed. The new message that is issued further includes information identifying the path(s) in the communication multipath that have failed. Similarly, after the I/O control unit determines one or more paths in the communication multipath have been repaired after a failure, the I/O control unit may create and issue a message with a raised attention, informing that the path(s) have been repaired and are now operational. In response, the host may issue a DSO Define Path Usage command to allow usage to the repaired path(s), e.g., as will be described in further detail below.

In response to receiving the new message type, the host reads the command using the path and/or path group along with the attention interrupt. The host may ultimately determine whether a path recovery should be initiated in some approaches. In other approaches, the new message type may also be sent to one or more AI based models that are trained and configured to evaluate the attention interrupt and/or other information (e.g., metadata) included in the new message. In response to evaluating the new message and information (e.g., metadata) included therein, the host may create and issue a command that instructs the I/O control unit of the expected usage of one or more specified paths in a particular path group.

In some approaches, operation 306 includes issuing a request for a completed (e.g., filled, set, etc.) define subsystem operation (DSO) define path usage command to a host of the system. For example, the I/O control unit may raise an attention interrupt after building the new message and issuing it to the host. Thus, in response to reading the message issued by the I/O control unit, the host determines (e.g., with the help of one or more trained AI based models) whether to issue the DSO define path usage command. In situations where the host and/or AI based models determine to issue the DSO define path usage command, the host and/or AI based models may further set first and/or second flags, fill a list of interface IDs, and/or indicate a path group ID. This information may be incorporated into the DSO define path usage command and returned to the I/O control unit, e.g., as will be described in further detail below. It follows that in some approaches, the I/O control unit may convey at least some information to the host that determines (e.g., influences) how the parameters should be set or filled in the DSO define path usage command that is returned. For instance, information in the attention message preferably indicates the specific channel(s) to take action against.

In another example, in response to receiving the new message issued by the I/O control unit in operation 306, the host determines what to do in response to the attention interrupt included in the received new message (e.g., should recovery be initiated, should the DSO define path usage command be sent at all, etc.), as well as the content of the DSO define path usage commands that may be returned to the I/O command unit. For instance, the host may use one or more trained AI based models to evaluate past and/or present performance, current system settings, host preferences, etc., and determine whether multipath reconnections are allowed for specified path(s) and particular path group(s). The host may further use the AI based models to evaluate past and/or present performance, current system settings, host preferences, etc., and determine whether specified path(s) and particular path group(s) are able to present unsolicited status. In some approaches, the host and/or AI based models may decide to restrict presenting unsolicited status in order to focus remaining throughput on satisfying I/O requests that are received during the recovery procedure. Again, this may desirably maintain operation while directing new queries to other paths and/or implementing a processing delay.

However, the DSO command is preferably configured such that it provides the host an opportunity to instruct the I/O control unit of the expected usage of one or more specified paths in a particular path group and/or for all devices in the path group. Thus, by issuing a DSO define path usage command that has been configured to convey specific information from a particular source (e.g., host), approaches herein are able to gain insight as to how certain paths in a communication multipath should be used during a recovery period. This allows approaches herein to maintain high throughput even during path recovery procedures, e.g., as will be described in further detail below.

In preferred approaches the command issued in operation 306 is configured to provide a variety of information that is relevant in determining whether any communication paths extending across a distributed system will experience (or are experiencing) any performance related issues. From operation 306, method 300 advances to operation 308. There, operation 308 includes receiving a DSO define path usage command from the host. According to one example, which is in no way intended to be limiting, the DSO define path usage command includes a set first flag that is configured to restrict or allow multipath reconnections for specified path(s) and the particular path group(s) that are identified in the command. In other words, the first flag of the command has been configured to indicate whether multipath reconnections should be satisfied using specific paths during a recovery procedure. In some approaches, multipath reconnections may be restricted in order to focus remaining throughput on satisfying I/O requests that are received during the recovery procedure. This may desirably maintain operation while directing new queries to other paths and/or implementing a processing delay.

The DSO define path usage command received in operation 308 may also include a set second flag that is configured to restrict or allow the specified path(s) and the particular path group(s) to present unsolicited status. In other words, the second flag of the command may be configured to indicate whether presenting unsolicited status should be permitted using specific paths during a recovery procedure. In some approaches, presenting unsolicited status may be restricted in order to focus remaining throughput on satisfying I/O requests that are received during the recovery procedure. Again, this may desirably maintain operation while directing new queries to other paths and/or implementing a processing delay.

The DSO define path usage command received in operation 308 may also include a filled list of interface IDs that correspond to (e.g., represent) the respective path(s) specified in the command. Accordingly, a host may modify the issued command to include a list of interface IDs which outline (e.g., identify) the paths that are to be restricted from use and/or permitted to be used during the recovery process. The DSO define path usage command received may thereby further be configured to indicate a path group ID which determines (e.g., identifies) the particular path group(s) affected by the flags and/or other details returned in operation 308. It follows that operation 308 includes receiving a DSO define path usage command that has been modified by a host. However, in some approaches operation 308 includes receiving a DSO define path usage command that has been modified based on outputs produced by trained AI based models. The AI based models may be trained over time using performance data, training data, received inputs, etc., to evaluate the performance of various paths in a communication multipath, and modify a DSO define path usage command such that each of the paths are ultimately modified to perform as preferred. As noted above, the command received in operation 308 may include a first flag that is set indicating whether multipath reconnections for the specified path(s) in the particular path group should be restricted or allowed. In other words, the command may include an indication (e.g., a first flag) of whether specified paths in one or more path groups should be permitted (e.g., used) to perform multipath reconnections or not. The command received in operation 308 may also include a second flag that is set indicating whether the specified path(s) in the particular path group should be used to present unsolicited statuses or not. In other words, the command may include an indication (e.g., a second flag) of whether specified paths in one or more path groups should be permitted (e.g., used) to present unsolicited statuses or not.

It follows that the set first flag, the set second flag, the filled list of interface IDs, and the identified path group ID received in operation 308 are able to cause (e.g., configured to instruct) the I/O control unit to ensure that each path of a communication multipath is used to conduct specific types of operations during recovery of one or more failed paths in the communication multipath. In some approaches, flags set in a response apply to all devices in an identified path group ID. In other words, the indications made in a received response may be applied to any devices that are connected to the communication paths in any path group(s) identified in the response. While some approaches herein describe this path specific performance as being indicated with a flag, this is in no way intended to be limiting. For example, different approaches may encrypt this indication, protecting it from being intercepted and/or modified in transit. Other approaches may compress commands and/or information exchanged with a target location (e.g., host) to reduce network overhead.

The response received in operation 308 is preferably evaluated and used to configure at least some of the paths in the communication multipath. For instance, operation 310 includes using information in the received DSO define path usage command to configure at least the path(s) that are identified therein. Operation 310 thereby includes using the first flag and the second flag as set in the received DSO define path usage command to configure at least the path(s) that are identified by the filled list of interface IDs and the identified path group ID(s). In other words, operation 310 uses information injected into the received DSO define path usage command to adjust how each of the paths in a communication multipath operate (e.g., the types of operations and/or data the paths are used to transfer), including any failed paths that have experienced errors. As noted above, one or more operations of method 300 may be performed by an I/O control unit (e.g., see I/O control unit 215 of FIG. 2A-2B). It follows that in some approaches, operation 310 includes sending and/or performing one or more instructions that cause each of the communication paths to be utilized as desired.

With continued reference to FIG. 3, method 300 advances from operation 310 to operation 312 after using the command to configure the paths in the communication multipath, including any paths that have failed. There, operation 312 includes recovering the failed path(s). In other words, operation 312 includes initiating a recovery procedure that causes any paths in the communication multipath that have experienced an error and/or otherwise been identified in the received DSO define path usage command, to operate differently. The steps that are taken to alter the performance of each path may differ depending on the type of path (e.g., logical, physical, etc.) and/or the target performance. In some approaches, a logical communication path may simply be redefined using components that create the physical communication path(s) over which the logical communication path extends between two or more locations in a system (e.g., see system 200 of FIGS. 2A-2B). In other approaches, a physical communication path and/or the components thereof may be replaced, repaired, updated, modified, etc., in order to recover one or more failed communication paths.

As noted above, approaches herein are desirably able to maintain system throughput even while logical and/or physical communication paths are being recovered. Accordingly, the process of recovering the failed path(s) in operation 312 may also include evaluating and satisfying any incoming requests accordingly. In one example, a multipath reconnect received along a communication path that has experienced an error and is being repaired may be denied or redirected in accordance with an indication (e.g., set first flag in the received command) of how multipath reconnects should be processed. In another example, a failed communication path being repaired may be used to present unsolicited status in accordance with an indication (e.g., second flag in the received command not being set) of how unsolicited statuses should be processed. In still another example, a failed communication path may continue to be used to transfer I/O requests (e.g., traffic) during the repair process.

According to one approach, the failed path(s) include logical connections, and using the set first flag and the set second flag to configure the failed path(s) includes causing the failed path(s) to not perform multipath reconnections and/or not present unsolicited statuses. However, the failed path(s) are able (e.g., permitted, configured such that they are allowed, etc.) to perform I/O commands even during the recovery phase. Only partially taking the failed logical connections offline during the recovery process desirably allows communication paths herein to maintain some operation (e.g., I/O requests) while deferring or ignoring other types of requests (e.g., multipath reconnects and/or present unsolicited status). Moreover, the remaining paths in the communication multipath that have not experienced any failures are able (e.g., permitted, configured such that they are allowed, etc.) to operate as desired. For example, communication paths not specifically identified in the DSO define path usage command received in operation 308 are configured to perform I/O commands, perform multipath reconnections, and present unsolicited statuses during the recovery of any failed paths. In other words, multipath reconnections and unsolicited statuses are implemented during the recovery procedure by paths in the communication multipath that remain operational and have not experienced failures. Again, the failed logical and/or physical paths are restricted to partial use/operation, while remaining paths in the same communication multipath (and/or another multipath) are used to maintain remaining operations.

In response to the failed path(s) being recovered, method 300 advances from operation 312 to operation 314. There, operation 314 includes resuming using the recovered path(s) to perform multipath reconnections and present unsolicited statuses. In other words, operation 314 includes using the I/O control unit to revert each of the communication paths to being used according to a base profile. In some approaches, this may be achieved by causing the I/O control unit to reset an assignment of each communication path, e.g., as would be appreciated by one skilled in the art after reading the present description.

For some approaches, instead of relying on an addition directive to later revert and allow path usage, a time value could be implemented (e.g., passed). For instance, in situations where a path recovery typically takes “X” period of time, that X could be passed in the response (e.g., DSO define path usage command) that is ultimately received and implemented. This way, the control unit would only restrict usage for “X” amount of time, and then allow the default communication path usage to be resumed after the period has ended. This desirably avoids additional channel overhead and automatically adjusts performance of the different communication paths. Moreover, in situations where the recovery of communication paths is performed in less predictable time periods, the host could set a longer period “X” to restrict usage, in combination with issuing an Allow Path Usage command before the period “X” expires to start using the path again.

Again, the various approaches presented in conjunction with method 300 are desirably able to provide protection on the recovery path usages via a host directive to the control unit that is able to define correct (e.g., permitted or preferred) path usage. This desirably avoids the complicated and resource intensive process of removing paths from path groups, only to expend a similar amount of resources to add the recovered paths to the same or other path groups. The operations of method 300 are thereby desirably able to reduce overall consumption of system resources (e.g., available compute overhead, network bandwidth, electrical current and/or voltage, etc.) while maintaining performance of received I/O requests with no added latency. Method 300 may thereby be used to seamlessly implement updates to software and/or hardware of a network, without impacting performance in real-time. Implementations herein are able to overcome processing based issues that have plagued conventional systems as a result. These improvements are applicable for DSO commands, Set Path Group ID (SPID) commands, or any other desired protocols. It follows that while some approaches herein are described in the context of DSO commands, this is in no way intended to be limiting. Rather, implementations herein are able to ensure that I/O processing is not disrupted by this failover failback process regardless of the type of commands that are used. Thus, rather than relying on I/O timeouts to detect a connection issue on the host system, hosts will be notified much earlier and thereby can retry I/O requests on surviving paths much faster than has been conventionally achievable.

According to a non-limiting example, the IBM System z dynamic pathing architecture used with tape and DASD control units, which allows up to 8 logical paths from a host system to an I/O device. With implementations using System z, an I/O control unit may contain one or more I/O devices, each of which share the same set of logical paths. The control program on a host system may thereby issue an I/O command on each logical path to a device to add a path to the path group for that device. As needed, the control program may issue other I/O commands on logical paths to a device to remove that logical path from the respective path group.

According to another non-limiting example, a SPID command itself can be used with a new action akin to Establish Group, Resign from Group, or Disband Group to instead define whether path usage should be restricted and/or allowed. However, a new DSO allows for larger flexibility in multiple paths and behavior. As noted above, in situations where the restrict option is set, instead of relying on an addition directive to later allow path usage, a time value could be passed in some approaches. One can envision that if recovery typically takes “X” period of time, that X would be passed in the command. This way, the control unit would only restrict access for X and then allow the default path usage to be resumed at the end of that period.

In other approaches in which the control unit is honoring a restrict path usage directive, the path can be returned to default usage without the Allow Path Usage directive being issued to the control unit. For example, if a System Reset, Resign from Group, or Disband Group is received for the path, default usage of the paths may be resumed. The interface ids sent may be the same as those reported from the control unit for ports. In another example, a host could indicate to the control unit that a specific Z endpoint should not be used. Additionally, all the logical channel paths for a particular physical channel path (e.g., CHPID) may be controlled by the directive to restrict or allow path usage. The control unit would manage this path usage for all the volumes connected to this particular endpoint. This could be limited to a particular host using the physical channel in some approaches. In other approaches, this could be extended to affecting any host using the given physical channel.

According to a non-limiting example, 4 hosts (LPARS) in a subsystem are using a same physical path. At least one of the hosts experiences issues on the physical path and initiates a recovery procedure. Approaches herein allow this host to issue a Restrict Path Usage directive that causes the control unit to restrict path usage (e.g., for all the unsolicited statuses, multipath reconnects, etc.), for any host(s) using this failed path. This first host would thereby be able to complete their recovery and allow other hosts to not be impacted by any repairs occurring on the physical path (e.g., from a status and/or reconnect perspective). The other hosts using the same physical path may further be able to use the physical path for respective I/Os. Thus, even in situations where more than one host detected issues with the physical path and initiated their own recovery (e.g., even including sending their own directives), whichever host restricted the physical path usage first would benefit the others by not getting excess ‘noise’ during their own recovery processing. However, in situations where one host has restricted the path for use and the recovery fails, the other host may initiate their own recovery procedures, e.g., as would be appreciated by one skilled in the art after reading the present description.

At a high level, it follows that the host control program in approaches herein are able to issue Define Path Usage I/O commands (probably on an unaffected path) to instruct the I/O control unit, for all I/O devices in the control unit, to not use one or more paths to the LPAR for presenting unsolicited status or reconnecting. Moreover, this may be performed at the start of recovery processing for one or more paths. However, at the conclusion of the path recovery, the host control program may issue a Define Path Usage I/O command to instruct the I/O control unit that it can resume using the one or more paths to the LPAR for presenting unsolicited status and/or performing multipath reconnecting. Again, approaches herein are thereby able to achieve host directive to control (e.g., allow/restrict) path usage for unsolicited events and/or reconnects.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method for avoiding use of paths of a communication multipath attached to an input/output (I/O) control unit, comprising:
receiving, from a host, a define subsystem operation (DSO) define path usage command configured to instruct the I/O control unit of expected usage of one or more specified paths in a particular path group for all devices in the path group,
wherein the DSO define path usage command includes:
a set first flag, the first flag being configured to restrict or allow multipath reconnections for the specified path(s) and the particular path group,
a set second flag, the second flag being configured to restrict or allow the specified path(s) and the particular path group to present unsolicited status,
a filled list of interface identifications (IDs) configured to determine the respective specified path(s), and
an identified path group ID configured to determine the particular path group.

2. The method of claim 1, further comprising:
using the set first flag and the set second flag to configure paths which correspond to the filled list of interface IDs and the identified path group ID.

3. The method of claim 2, wherein the set first flag, the set second flag, the filled list of interface IDs, and the identified path group ID are configured to instruct the I/O control unit of expected usage of the paths that correspond to the filled list of interface IDs and the identified path group ID during recovery of one or more failed paths in the communication multipath.

4. The method of claim 2, wherein the set first flag and the set second flag apply to all devices in the identified path group ID.

5. The method of claim 1, wherein the paths in the communication multipath are logical and/or physical connections.

6. A computer program product comprising:
one or more computer-readable storage media; and
program instructions stored on the one or more storage media to perform operations comprising:
in response to experiencing a failure in one or more paths of a communication multipath attached to an input/output (I/O) control unit, receiving, from a host, a define subsystem operation (DSO) define path usage command configured to instruct the I/O control unit of expected usage of one or more specified paths in a particular path group for all devices in the path group,
wherein the DSO define path usage command includes:
a set first flag, the first flag being configured to restrict or allow multipath reconnections for the specified path(s) and the particular path group,
a set second flag, the second flag being configured to restrict or allow the specified path(s) and the particular path group to present unsolicited status,
a filled list of interface identifications (IDs) configured to determine the respective specified path(s), and
an identified path group ID configured to determine the particular path group.

7. The computer program product of claim 6, wherein the operations further comprise:
using the set first flag and the set second flag to configure paths which correspond to the filled list of interface IDs and the identified path group ID.

8. The computer program product of claim 7, wherein the set first flag, the set second flag, the filled list of interface IDs, and the identified path group ID are configured to instruct the I/O control unit of expected usage of the paths that correspond to the filled list of interface IDs and the identified path group ID during recovery of one or more failed paths in the communication multipath.

9. The computer program product of claim 7, wherein the set first flag and the set second flag apply to all devices in the identified path group ID.

10. The computer program product of claim 6, wherein the paths in the communication multipath are logical and/or physical connections.

11. A computer system comprising:
a processor set;
one or more computer-readable storage media; and
program instructions stored on the one or more storage media to cause the processor set to perform operations comprising:
in response to experiencing a failure in one or more paths of a communication multipath attached to an input/output (I/O) control unit, receiving, from a host, a define subsystem operation (DSO) define path usage command configured to instruct the I/O control unit of expected usage of one or more specified paths in a particular path group for all devices in the path group,
wherein the DSO define path usage command includes:
a set first flag, the first flag being configured to restrict or allow multipath reconnections for the specified path(s) and the particular path group,
a set second flag, the second flag being configured to restrict or allow the specified path(s) and the particular path group to present unsolicited status,
a filled list of interface identifications (IDs) configured to determine the respective specified path(s), and
an identified path group ID configured to determine the particular path group.

12. The computer system of claim 11, wherein the operations further comprise:
using the set first flag and the set second flag to configure paths which correspond to the filled list of interface IDs and the identified path group ID.

13. The computer system of claim 12, wherein the set first flag, the set second flag, the filled list of interface IDs, and the identified path group ID are configured to instruct the I/O control unit of expected usage of the paths that correspond to the filled list of interface IDs and the identified path group ID during recovery of one or more failed paths in the communication multipath.

14. The computer system of claim 12, wherein the set first flag and the set second flag apply to all devices in the identified path group ID.

15. The computer system of claim 11, wherein the paths in the communication multipath are logical and/or physical connections.

16. A method for selectively preventing use of paths of a communication multipath attached to an input/output (I/O) control unit comprising:
experiencing a failure on one or more of the paths in the communication multipath; and
in response to experiencing the failure, building and issuing a new message type with a raised attention interrupt to a host;
receiving, from the host, a define subsystem operation (DSO) define path usage command,
wherein the DSO define path usage command includes:
a set first flag indicating whether multipath reconnections for the failed path(s) in a particular path group should be restricted or allowed,
a set second flag indicating whether to restrict or allow the failed path(s) in the particular path group from presenting unsolicited statuses,
a filled list of interface identifications (IDs) identifying the failed path(s), and
a path group ID determining the particular path group; and
using the set first flag and the set second flag to configure the failed path(s) which correspond to the filled list of interface IDs and the path group ID.

17. The method of claim 16, further comprising:
in response to using the set first flag and the set second flag to configure the failed path(s), recovering the failed path(s); and
in response to the failed path(s) being recovered, causing an input/output (I/O) control unit to resume using the recovered path(s) to perform multipath reconnections and present unsolicited statuses.

18. The method of claim 16, wherein the failed path(s) include logical connections, wherein the using the set first flag and the set second flag to configure the failed path(s) includes:
causing the failed path(s) to not perform multipath reconnections and/or not present unsolicited statuses.

19. The method of claim 18, wherein the failed path(s) are able to perform I/O commands.

20. The method of claim 16, wherein the paths in the communication multipath are logical and/or physical connections.

21. The method of claim 16, wherein remaining paths in the communication multipath are able to:
perform I/O commands,
perform multipath reconnections, and
present unsolicited statuses.

22. A computer system comprising:
a processor set;
one or more computer-readable storage media; and
program instructions stored on the one or more storage media to cause the processor set to perform operations comprising:
experiencing a failure on one or more of paths of a communication multipath attached to an input/output (I/O) control unit; and
in response to experiencing the failure, building and issuing a new message type with a raised attention interrupt to a host;
receiving, from the host, a define subsystem operation (DSO) define path usage command;
wherein the DSO define path usage command includes:
a set first flag indicating whether multipath reconnections for the failed path(s) in a particular path group should be restricted or allowed,
a set second flag indicating whether to restrict or allow the failed path(s) in the particular path group from presenting unsolicited statuses,
a filled list of interface identifications (IDs) identifying the failed path(s), and
a path group ID determining the particular path group; and
using the set first flag and the set second flag to configure the failed path(s) which correspond to the filled list of interface IDs and the path group ID.

23. The computer system of claim 22, wherein the operations further comprise:
in response to using the set first flag and the set second flag to configure the failed path(s), recovering the failed path(s); and
in response to the failed path(s) being recovered, causing an input/output (I/O) control unit to resume using the recovered path(s) to perform multipath reconnections and present unsolicited statuses.

24. The computer system of claim 22, wherein the failed path(s) include logical connections, wherein the using the set first flag and the set second flag to configure the failed path(s) includes:
causing the failed path(s) to not perform multipath reconnections and/or not present unsolicited statuses,
wherein the failed path(s) are able to perform I/O commands.

25. The computer system of claim 22, wherein the paths in the communication multipath are logical and/or physical connections.
